(19) United States
(12) Patent Application Publication
(10) Pub. No.: US 2017/0306117 A1
(43) Pub. Date: Oct. 26, 2017

(54) EPOXY RESIN COMPOSITION, CURED RESIN, PREPREG AND FIBER-REINFORCED COMPOSITE MATERIAL

(71) Applicant: TORAY INDUSTRIES, INC., Tokyo (JP)

(72) Inventors: Ayako FUSE, Nagoya-shi (JP); Nobuyuki TOMIOKA, Nagoya-shi (JP); Shizue KOYANAGI, Iyo-gun (JP); Nobuyuki ARAI, Iyo-gun (JP); Shirou HONDA, Iyo-gun (JP)

(73) Assignee: TORAY INDUSTRIES, INC., Tokyo (JP)

(21) Appl. No.: 15/509,968

(22) PCT Filed: Aug. 27, 2015
(86) PCT No.: PCT/JP2015/074190

§ 371 Date: Mar. 9, 2017

(30) Foreign Application Priority Data
Oct. 29, 2014 (JP) 2014-219935

(51) Int. Cl. C08J 5/24; C08G 59/38; C08G 59/24; C08J 5/04; C08L 63/00; C08G 59/32; C08G 59/50

(52) U.S. Cl. CPC C08J 5/24; C08G 59/3227; C08G 59/38; C08G 59/504; C08J 5/042; C08L 63/00; C08G 59/245; C08J 2363/02; C08J 2477/02; C08J 2481/06; C08L 2205/02; C08L 2205/035; C08J 2463/00

(57) ABSTRACT

Provided is an epoxy resin composition with improved heat resistance and resin elongation. Further provided is a fiber-reinforced composite material which uses the epoxy resin composition and thereby excels in compression strength in high-temperature environments and interlaminar toughness. The epoxy resin composition comprises the constituents [A], [B] and [C], 8-40 mass % of [B] is contained in the epoxy resin composition. The number of moles of active hydrogen contained in [C] is 1.05-2.0 times the number of moles of epoxy groups contained in the entire epoxy resin composition, in a cured resin formed by curing the epoxy resin composition and having a degree of curing of at least 90% obtained by DSC (differential scanning catorimetry), [A], [B] and [C] form a monolayer structure, or a phase separation structure of less than 500 nm. The rubber state modulus of elasticity Y (MPa) and glass transition temperature X (° C.) obtained by DMA (dynamic mechanical analysis) of the cured resin satisfy formula (1). [A] amine type epoxy resin [B] thermoplastic resin [C] aromatic amine

0.19X/° C.-31.5≦Y/MPa≦0.19X/° C.-27 (1)

### TECHNICAL FIELD

The present invention relates to fiber reinforced, composite material suitable for aerospace applications, cured resin and prepreg for the production thereof, and epoxy resin compositions preferred as matrix resin thereof.

### BACKGROUND ART

High in specific strength and specific modulus, fiber reinforced composite materials containing reinforcement fiber such as carbon fiber and aramid fiber nave recently been used widely for manufacturing structural materials for aircraft and automobiles, sporting goods such as tennis rackets, golf shafts, and fishing poles, as well as general industrial applications. Fiber reinforced composite materials are manufactured by, for example, stacking a plurality of layers of prepreg, that is, sheet-like intermediate material prepared by impregnating reinforcement fiber with uncured matrix resin, followed by curing them by heating, or injecting liquid resin into reinforcement fiber placed in a mold, followed by curing the resin by heating, which is railed the resin transfer molding method.

Of these production methods, the use of prepreg has the advantage of enabling easy production of high performance fiber reinforced composite material because the orientation of the reinforcement fiber can be controlled accurately and also because a high degree of design freedom is ensured for the stack structure As the matrix resin of such prepreg, thermosetting resins are mainly used from the viewpoint of heat resistance and productivity and in particular, epoxy resin is preferred Horn the viewpoint of mechanical characteristics such as adhesion between resin and reinforcement fiber, their dimensional stability, and the strength and rigidity of composite materials produced from them.

Among others, amine type epoxy resins, which can form cured materials with a small epoxy equivalent and a high crosslink density, have been adopted favorably as matrix resin of reinforcement fibers that are used for producing fiber reinforced composite materials for aerospace applications In which high strength characteristics and durable stability are required. Although they have made it possible to design resins with high elastic modulus and high heat resistance, such resins tend to form cured materials with low deformability and tow ductility.

To solve the problems with the low ductility of the amine type epoxy resin, some attempts have been made including blending it with thermoplastic resin with high ductility to form a phase separated structure with epoxy resin. However, such methods tend to have problems such as a decline in elastic modulus, heat resistance, etc., deterioration in processability due to increased viscosity, and deterioration in quality due to generation of voids.

To prevent such increase in viscosity of resin composition, a design method aiming to increase the ductility by blending polysulfone with a low number average molecular weight was developed (Patent document 1). Specifically, it has been disclosed that a large ductility improving effect can be achieved by adding polysulfone with a number average molecular weight of 3,000 to 5,100 in large amounts, namely to 20 to 50 mass %, to an epoxy resin composition.

It has also been disclosed that heat resistance and elastic modulus can be improved by using an epoxy resin containing two or more ring structures, each having four or more members, and at least one amine type glycidyl group connected directly to these ring structures (Patent document 2).

### PRIOR ART DOCUMENTS

### Patent Documents

Patent document 1: Japanese Unexamined Patent Publication No. SHO 61-228016

Patent document 2: International Publication WO 2010/109929

### SUMMARY OF THE INVENTION

### Problems to be Solved by the Invention

The method disclosed in Patent document 1, however, cannot achieve sufficiently high heat resistance and resin elongation percentage to meet the characteristics required in fiber reinforced composite materials for aerospace applications.

The method disclosed In Patent document 2 also fails to provide cured resin with sufficiently high elongation percentage or fiber reinforced composite material with sufficiently high interlayer ductility.

Thus, it has been difficult to develop an epoxy resin composition that has a required level of elongation percentage, heat resistance, ductility, and elastic modulus.

Accordingly, an object of the present invention is to provide an epoxy resin composition having an improved resin elongation percentage and heat resistance. In addition, another object is to make use of such an epoxy resin composition to provide a fiber reinforced composite material having high interlayer ductility and high compression strength in a high temperature environment.

### Means of Solving the Problems

As a result of studies for solving the problem, the inventors have identified an epoxy resin composition having a structure as described below and arrived at the present invention. Specifically, the present invention has the constitution described below.

An epoxy resin composition comprising the constitutional elements [A], [B], and [C] listed below, [B] accounting for 8 to 40 mass % of the epoxy resin composition, the number of moies of the active hydrogen contained in [C] being 1.05 to 2.0 times as large as the number of motes of epoxy groups contained in the entire epoxy resin composition, [A], [B], and [C] having a single phase structure or a below-500-nm phase separated structure in cured material with a cure degree of 90% or more as determined by DSC (differential scanning calorimetry) produced by curing the epoxy resin composition, and the glass transition temperature X (° C.) and the rubber state elastic modulus Y (MPa) of the cured material as determined by DMA (dynamic mechanical analysis) meeting the Equation (1) given below: [A] amine type epoxy resin [B] thermoplastic resin [C] aromatic amine

0.19X/° C.−31.5≦Y/MPa≦19X/° C.−27 (1)

For the present invention, furthermore, the aforementioned epoxy resin composition can be cured to produce cured resin; the aforementioned epoxy resin composition can serve to impregnate reinforcement fiber to produce prepreg; fiber reinforced composite material containing the aforementioned cured resin and reinforcement fiber can be produced; and the prepreg can be cured to produce fiber reinforced composite material.

### Advantageous Effect of the Invention

The present invention serves to provide an epoxy resin composition having an improved resin elongation percentage and heat resistance. In addition, it also makes use of such an epoxy resin composition to provide a fiber reinforced composite material having high interlayer ductility and high compression strength in a high temperature environment.

### DESCRIPTION OF PREFERRED EMBODIMENTS

Described in detail below are the epoxy resin composition, cured resin, prepreg, and fiber reinforced composite material according to the present invention.

The epoxy resin composition according to the present invention includes an amine type epoxy resin [A], an thermoplastic resin [B], and an aromatic amine [C], [B] accounting for 8 to 40 mass % of the epoxy resin composition, the number of moles of the active hydrogen contained in [C] being 1.05 to 2.0 times as large as the number of moles of the epoxy groups contained in the entire epoxy resin composition, [A], [B], and [C] forming a single phase structure or a below-500-nm phase separated structure in cured material with a cure degree of 90% or more as determined by DSC (differential scanning calorimetry) produced by curing the epoxy resin composition, and the glass transition temperature X (° C.) and the rubber state elastic modulus Y (MPa) of the cured material as determined by DMA (dynamic mechanical analysis) meeting the Equation (1) given below:

0.19X/° C.−31.5≦Y/MPa≦0.19X/° C.−27 (1)

Such cured material as referred to for the present invention that is produced by curing an epoxy resin composition and has a DSC cure degree of 90% or more is one with a cure degree of 90% or more as calculated by the equation given below from the total calorific value QT of the epoxy resin composition determined by DSC (differential scanning calorimetric) and the residual calorific value QR of the cured material.

Cure degree (%)=(QT−QR)/QT×100 For the present invention, the parameters X and Y in Equation (1) are associated with cured material prepared by heating and curing the epoxy resin composition according to the present invention under temperature conditions where the cure degree as determined by DSC is to be 90% or more and calculated from a scatter diagram in terms of storage elastic modulus and temperature that is constructed based on temperature rising measurements by DMA (dynamic mechanical analysis). The glass transition temperature is the temperature where the tangent drawn in the glass region and the tangent drawn in the glass transition region intersect each other in the scatter diagram. The rubber state elastic modulus is the storage elastic modulus at a temperature 50° C. higher than the glass transition temperature.

Fiber reinforced composite material produced from the epoxy resin composition according to the present invention should form cured epoxy resin material that has a relation between the glass transition temperature and the rubber state elastic modulus as shown by the equation 0.19X/° C.−31.5≦Y/MPa ≦0.19X/° C.−27, preferably 0.19X/° C.−31.5≦Y/MPa≦0.19X/° C.−28. A desired heat resistance and elongation percentage can be achieved simultaneously if the glass transition temperature and the rubber state elastic modulus are in this range.

If the epoxy resin composition has a rubber state elastic modulus higher than 0.19X/° C.−27, the rubber state elastic modulus is so high that the plastic deformability will decline and that the fiber reinforced composite material will be poor in interlayer ductility. If it is smaller than 0.19X/20 C.−31.5, on the other hand, the rubber state elastic modulus is so low that the cured epoxy resin material will fail to have sufficient elastic modulus, possibly leading to fiber reinforced composite material lacking in compression strength at high temperatures.

The substances that can work as the amine type epoxy resin [A] for the present invention include, for example, tetraglycidyl diaminodiphenyl methane, tetraglycidyl diaminodiphenyl sulfone, tetraglycidyl xylylene diamine, triglycidyl aminophenol, triglycidyl aminocresol, diglycidyl aniline, diglycidyl toluidine, halogen substitutes thereof, alkyl substitutes thereof, and hydrogenated products thereof, in particular, tetraglycidyl diaminodiphenyl methane, triglycidyl aminophanol, halogen substitutes thereof, alkyl substitutes thereof, and hydrogenated products thereof are preferred because they serve to increase the elastic modulus and heat resistance.

Usable commercial products of tetraglycidyl dlaminodiphenyl methane include Sumiepoxy (registered trademark) ELM434 (manufactured by Sumitomo Chemical Co., Ltd,), YH434L (manufactured by Nippon Steel & Sumikin Chemical Co., Ltd., jER (registered trademark) 604 (manufactured by Mitsubishi Chemical Corporation), and Araldite (registered trademark) MY720, Araldite (registered trademark) MY721, Araldite (registered trademark) MY9512, and Araldite (registered trademark) MY9663 (all manufactured by Huntsman Advanced Materials Gmbh).

Commercially available products of tetraglycidyl diamainodiphenyl sulfone include TG3DAS (manufactured by Mitsui Fine Chemical, inc.).

Usable commercial products of tetraglycidyl xylylene diamines and hydrogenated products thereof include TETRAD (registered trademark) −X and TETRAD (registered trademark) −C (both manufactured by Mitsubishi Gas Chemical Co., Inc.).

Useful commercial products of triglycidyl aminophenol and triglycidyl aminocresol include SUMI-EPOXY (registered trademark) ELM100, SUMI-EPOXY (registered trademark) ELM120 (both manufactured by Sumitomo Chemical Co., Ltd.), Araldite (registered trademark) MY0600, Araldite (registered trademark) MY0510, and Araldite (registered trademark) MY0600 (all manufactured by Huntsman Advanced Materials Gmbh), and jER (registered trademark) 830 (manufactured by Mitsubishi Chemical Corporation).

Commercially available products of diglycidyl aniline include GAN (manufactured by Nippon Kayaku Co., Ltd.) and PxGAN (manufactured by foray Fine Chemicals Co., Ltd.).

Commercially available products of diglycidyl toluidine include GOT (manufactured by Nippon Kayaku Co., Ltd.).

For the present invention, amine type epoxy resin [A] preferably accounts for 50 to 100 parts by mass, more preferably 70 to 100 pasts by mass, in the total quantity, or 100 parts by mass, of the epoxy resin. If the amine type epoxy resin accounts only for less than 50 parts by mass relative to the total quantity, or 100 parts by mass, of the epoxy resin, it may lead to an epoxy resin composition that lacks in heat resistance and elastic modulus. Furthermore, it may result in fiber reinforced composite material with a decreased compression strength.

For the epoxy resin composition according to the present invention, the amine type epoxy resin [A]preferably contains a bifunctional amine type epoxy resin and a tri- or more functional amine type epoxy resin. The existence of a bifunctional amine type epoxy resin serves to increase the distances between crosslinking points, leading to an increase in elongation percentage. Furthermore, the existence of a tri- or more functional amine type epoxy resin serves to improve the heat resistance and elastic modulus, leading to a well-balanced resin corn position.

The epoxy resin may contain other epoxy resin components other than the amine type epoxy resin [A] unless it impairs the advantageous effect of the invention. Such components may be used singly or as a combination of a plurality thereof. Specifically, they include phenol novolac type epoxy resin, cresol novolac type epoxy resin, resorcinol type epoxy resin, dicyclopentsdiene type epoxy resin, urethane- or isocyanate-modified epoxy resin, epoxy resin with a biphenyl backbone, epoxy resin with a fluorene backbone, and bisphenol type epoxy resin such as bisphenol A type, bisphenol F type, bisphenol S type, and bisphenol AD type, as well as halogen substitutes, alkyl substitutes, and hydrogenated products of these bisphenols. Specific examples of such epoxy resin include the following.

Commercial products of phenol novolac type epoxy resin Include jER (registered trademark) 152, jER (registered trademark) 154 (both manufactured by Mitsubishi Chemical Corporation), EPICLON (registered trademark) N-740, EPICLON (registered trademark) N-770, and EPICLON (registered trademark) N-775 (all manufactured by DIC).

Commercial products of cresol novolac type epoxy resin include EPICLON (registered trademark) N-660, EPICLON (registered trademark; N-665. EPICLON (registered trademark) N-670, EPICLON (registered trademark) N-673, and EPICLON (registered trademark) N-695 (ail manufactured by DIC), and EOCN-1020. EOCN-102S, and EOCN-104S (all manufactured by Nippon Kayaku Co., Ltd).

Specifically, commercial products of resorcinol type epoxy resin include DENACOL (registered trademark) EX-201 (manufactured by Nagase ChemteX Corporation).

Commercial products of dicyclopentadiene type epoxy resin include EPICLON (registered trademark) HP7200, EPICLON (registered trademark) HP7200L, and EPICLON (registered trademark) HP7200H (all manufactured by DIC), Tactix 558 (manufactured by Huntsman Advanced Materials Gmbh), XD-1000-1L, and XD-1000-2L (all manufactured by Nippon Kayaku Co., Ltd,).

Commercial products of urethane- or isocyanate-modified epoxy resin include AER4152 (manufactured by Asahi Kasei E-materials Corporation) and ACR1348 (manufactured by Asahi Denka Co. Ltd.), which have an oxazolidone ring.

Commercial products of epoxy resin with a biphenyl backbone include jER (registered trademark) YX4000H, jER (registered trademark) YX4000, and jER (registered trademark) YL6616 (all manufactured by Mitsubishi Chemical Corporation), and NC-3000 (manufactured by Nippon Kayaku Co., Ltd.).

Commercial products of epoxy resin with a fluorene backbone include ESF300 (manufactured by Nippon Steel & Sumikln Chemical Co., Ltd.), ONCOAT (registered trademark) EX-1010, ONCOAT (registered trademark) EX-1011, ONCOAT (registered trademark) EX-1012, ONCOAT (registered trademark) EX-1020, ONCOAT (registered trademark) EX-1030, ONCOAT (registered trademark) EX-1040. ONCOAT (registered trademark) EX-1050, and ONCOAT (registered trademark) EX-1051 (all manufactured by Nagase ChemteX Corporation).

Commercial products of bisphenol A type epoxy resin include EPOTOHTO (registered trademark) YD128 (manufactured by Nippon Steel & Sumikin Chemical Co., Ltd), jER (registered trademark) 825, jER (registered trademark) 828, jER (registered trademark) 834, jER (registered trademark) 1001, jER (registered trademark) 1004, jER (registered trademark) 1007, jER (registered trademark) 1009, and jER (registered trademark) 1010 (all manufactured by Mitsubishi Chemical Corporation).

Commercial products of bisphenol F type epoxy resin include EPICLON (registered trademark) 830, EPICLON (registered trademark) 835 (both manufactured by DIC), jER (registered trademark) 806, jER (registered trademark) 807. jER (registered trademark) 4004P, jER (registered trademark) 4007P, jER (registered trademark) 4009P, jER (registered trademark) 4010P (all manufactured by Mitsubishi Chemical Corporation), EPOTOHTO (registered trademark) YDF170, and EPOTOHTO (registered trademark) YDF2001 (both manufactured by Nippon Steel & Sumikin Chemical Co., Ltd.).

Commercial products of bisphenol S type epoxy resin include EPICLON (registered trademark) EXA-1514 (manufactured by DIC)

Commercial products of bisphenol AD type epoxy resin include EPOMIK (registered trademark) R710 and EPOMIK (registered trademark) R1710 (both manufactured by Printec, Inc.).

For the epoxy resin composition according to the present invention, the thermoplastic resin [B] is added by mixing or dissolution.

For the present invention, the amine type epoxy resin [A] is used in combination with the thermoplastic resin [B] in order to ensure high ductility while avoiding a decrease in heat resistance, leading to fiber reinforced composite material with largely improved interlayer ductility.

The thermoplastic resin [B] according to the present invention is a polymer material that is in a crystal state or in a glass state at room temperature and has thermoplasticity.

In general, this thermoplastic resin [B] is preferably one in which the backbone chain contains a bond selected from the group consisting of carbon-carbon bond, amide bond, imide bond, ester bond, ether bond, carbonate bond, urethane bond, thioether bond, sulfone bond, and carbonyl bond. This thermoplastic resin [B], furthermore, may partially contain a crosslinked structure and may be either crystalline or amorphous. It is particularly preferable that at least one resin selected from the group consisting of polyamide, polycarbonate, polyacetail polyphenylene oxide, polyphenylene sulfide, polyallylate, polyester, polyamide-imide, polyimide, polyetherimide, polyimide having a phenyl trimethyl indane structure, polysulfone, polyethersulfone, polyether ketone, polyether ether ketone, polyaramid, polyether nitrile, and polybenzimidazole, is dissolved in any epoxy resin component contained in the above epoxy resin composition.

For the present invention, the thermoplastic resin [B] accounts for 8 to 40 mass %, preferably 8 to 35mass %, more preferably 12 to 35 mass %, still more preferably 16 to 35 mass %, and most, preferably 20 to 30 mass %, in the epoxy resin composition.

The content of the thermoplastic resin [B] described above refers to the proportion relative to 100 mass % of the epoxy resin composition, but in the case where thermoplastic resin particles [D] are added as described later, the weight of the thermoplastic resin particles [D] is excluded from the total weight of the epoxy resin composition when calculating the content.

If the content of the thermoplastic resin [B] is less than 8 mass %, it will lead to cured resin with decreased ductility and the resulting fiber reinforced composite material will be poor in interlayer ductility. If it is more than 40 mass %, on the other hand, the thermosetting resin composition will suffer from an increase in viscosity, leading to a thermosetting resin composition and prepreg with insufficient production processability and handleability.

This thermoplastic resin [B] preferably has a weight average molecular weight in the range of 4,000 to 40,000 g/mol, more preferably 10,000 to 40,000 g/mol, and still more preferably 15,000 to 30,000 g/mol. If the weight average molecular weight is less than 4,000 g/mol, it may lead to cured epoxy resin material that lacks in elongation percentage and ductility. If it is more than 40.000 g/mol, on the other hand, the epoxy resin will be high in viscosity and difficult to knead when the thermoplastic resin is dissolved in the epoxy resin composition, possibly leading to difficulty in prepreg production.

Furthermore, the thermoplastic resin [B] according to the present invention preferably has a glass transition temperature of 150° C. or more, more preferably 200° C. or more, and still more preferably 220° C. or more. If the thermoplastic resin [B] has a glass transition temperature of less than 150° C., it may lead to a molded product that can suffer from heat deformation easily.

Substances that can serve as the thermoplastic resin [B] include polycarbonate (glass transition temperature (occasionally referred to as Tg) of 150° C.), polysulfone (Tg; 190° C.), polyether imide (Tg: 215° C.)t and polyether sulfone (Tg: 225° C.).

The glass transition temperature of the thermaplastic resin [B] as determined by using DSC (differential scanning calorimetric) as follows a specimen is heated at a heating rate of 20° C./min from 30° C. to a temperature 30° C. or more higher than an expected glass transition temperature, maintained at the temperature for 1 min, once cooled at a cooling rate of 20° C./min down, to 30° C., maintained at the temperature for 1 min. and then heated again at a heating rate of 20° C./min while observing the glass transition temperature (Tg).

Commercial products of polycarbonate include Panlite (registered trademark) K1300Y (manufactured by Teijin Limited).

Commercial products of polysulfone include Panlite (registered trademark) P-1700. Udel (registered trademark) P-3500LCD, and Virantage (registered trademark) DAMS VW-30500RP (all manufactured by Solvay Specialty Polymers).

Commercial products of polyetherimide include ULTEM (registered trademark) 1000 and ULTEM (registered trademark) 1010 (both manufactured by SABIC).

Commercial products of polyether sulfone include SUMIKAEXCEL (registered trademark) PES3600P, SUMIKAEXCEL (registered trademark) PES5003P SUMIKAEXCEL (registered trademark) PES5200P. SUMIKAEXCEL (registered trademark) PES7600P (all manufactured by Sumitomo Chemical Co., Ltd.), Ultrason (registered trademark) E2020P SR (manufactured by BASF), GAFONE (registered trademark) 3600 R, GAFONE (registered trademark) 3000R, and Virantage (registered trademark) VW-10700RP (all manufactured by Solvay Speciality Polymers).

Furthermore, the terminal functional group in the thermoplastic resin [B] is preferably the hydroxyl group, carboxyl group, amino group, thiol group, or an anhydride. Thermoplastic resins having a hydroxyl group include polyvinyl alcohol and phenoxy resins as well as polyvinyl acetal resins such as polyvinyl formal and polyvinyl butyral. Thermoplastic resins having s sulfonyl group include polyether sulfone.

Specifically, commercial products of phenoxy resin include PHENOTOHTO (registered trademark) YP-50 and PHENOTOHTO (registered trademark) YP-50S (both manufactured by Nippon Steel & Sumikin Chemical Co., Ltd.).

For the present invention, furthermore, it is also preferable to add thermoplastic resin particles [D] that are insoluble in the epoxy resin. The addition of such thermoplastic resin particles (D) leads to fiber reinforced composite material with improved interlayer ductility.

Useful materials for such thermoplastic resin particles [D] include thermoplastic resins that do not melt in the epoxy resin. Examples include polyamide, polyimide, polyamideimide, polycarbonate, and polyphenylene sulfide. In particular, polyamide is the most preferable, and preferable polyamide compounds include nylon 12, nylon 6, nylon 11, nylon 6/12 copolymers, Grilamide (registered trademark) TR-55, Grilamide (registered trademark) TR-90, Grilamide (registered trademark) TR-70LX (all manufactured by Emser Werke, Inc.), and other transparent, heat resistant polyamide compounds, in regard to the shape of the thermoplastic resin particles [D], they may be spherical particles, non-spherical particles, or porous particles, of which spherical particles are preferable because they ensure high viscoelasticity by preventing reduction in the flow characteristics of the resin and also ensure high impact resistance by eliminating potential starting points of stress concentrations.

Commercial products of polyamide particles include SP-500, SP-10 (both manufactured by Toray Industries. Inc.), Orgasol (registered trademark) 1002D, Orgasol (registered trademark) 2002, Orgasol (registered trademark) 3202 (all manufactured by ATOCHEM), and Trogamld (registered trademark) 75000 (manufactured by Daicel-Evonik Ltd.).

For the present invention, the aromatic amine [G] is a curing agent for the epoxy resin contained in the epoxy resin composition according to the present invention, and it is a compound containing active hydrogen that can react with the epoxy group.

Specific examples include diaminodiphenyl sulfone, diaminodiphenyl methane, diaminodiphenyl ether, bisaniline, and diaminobenzanilide.

In particular, diaminodlphenyl sulfone and isomers thereof are preferred. Diaminodiphenyl sulfone and isomers thereof are preferred because they serve to produce cured epoxy resin material with high heat resistance.

Such isomers of diaminodiphenyl sulfone include 3,3′-diaminodiphenyJ sulfone and 4,4′-diaminodiphenyl sulfone,

Here, the total quantity of such aromatic amine [C] should be such that the number of moles of active hydrogen contained in [C] is 1.05 to 2.0 times, preferably 1.1 to 1.8 times, and more preferably 1.2 to 1.5 times, as large as the number of moles of epoxy groups contained in the entire epoxy resin composition, if the number of moles of such active hydrogen is only less than 1.05 times as large as the number of moles of epoxy groups contained in the entire epoxy resin composition, the crosslink density will increase to decrease the resin's elongation percentage and in addition, the phase separation structure will become coarse, possibly leading to fiber reinforced composite material with insufficient interlayer ductility and compression strength. If it is more than 2.0 times, on the other hand, the heat resistance will decrease significantly while the viscosity of the epoxy resin composition will increase, making prepreg preparation difficult.

Commercial products of the aromatic amine [C] include SEIKACURE S (manufactured by Wakayama Seika Kogyo Co., Ltd.), MDA-220 (manufactured by Mitsui Chemicals, Inc.), jER Cure (registered trademark) W (manufactured by Mitsubishi Chemical Corporation), 3.3′-DAS (manufactured by Mitsui Fine Chemicals, Inc.), Lonzacure (registered trademark) M-DEA, Lonzacure (registered trademark) M-DIPA. Lonzacure (registered trademark) M-MIPA, and Lonzacure (registered trademark) DETDA 80 (all manufactured by Lonza).

These materials for the aromatic amine [C] may be used singly, or a plurality thereof may be used in combination. The composition to be used may contain epoxy resin and the aromatic amine [C], pad of which may be subjected to a preliminary reaction in advance. In some cases, this method can serve effectively for viscosity adjustment and storage stability improvement.

For the epoxy resin composition according to the present invention, if is preferable that the constituents (components) other than the aromatic amine [C] be first heated and kneaded uniformly at a temperature of about 160° C. and cooled to a temperature of about 80° C., followed by adding the aromatic amine [C] and further kneading, although methods to be used to mix the components are not limited to this.

The cured epoxy resin material according to the present invention can be obtained by heating and curing the epoxy resin composition according to the present invention under temperature conditions where the cure degree as determined by DSC is to be 90% or more. Such temperature conditions may be adjusted appropriately to suite the type and quantity of the curing agent and accelerator used, and in the case where diaminodiphenyl sulfone is used as curing agent, for example, the temperature condition of 180° C. for 2 hours can work favorably.

In the cured epoxy resin material according to the present invention, the amine type epoxy resin [A], the thermoplastic resin [B], and the aromatic amine [C] should form a single phase structure or a fine, below-500-nm phase separated structure.

A phase separated structure as referred to for the present invention is one in which a plurality of phases form a 10 nm or more phase separated structure. Compared to this, a single phase structure is one in which the components are mixed uniformly at the molecular level. For the present invention, a phase separated structure composed of a plurality of phases of less than 10 nm is assumed to be a single phase structure because it is difficult to identify each phase by transmission electron microscopy

The cured epoxy resin material according to the present invention should be such that the amine type epoxy resin [A] and the aromatic amine [C] coexist after being crosslinked through a curing reaction to form a phase in which the thermoplastic resin [B] is present in a compatible manner at the molecule level or forms a below-500-nm phase separated structure.

Having reactivity with the amine type epoxy resin [A] and the aromatic amine [C], the thermoplastic resin [B] is favored because it can form a stable single phase structure or a below-500-nm phase separated structure after being incorporated during curing reaction in the crosslinked structure formed of the amine type epoxy resin [A] and the aromatic amine [C]. Here, if the thermoplastic resin [B] is not contained, a single phase structure can form more easily, but the resulting cured material will have a largely decreased ductility. To ensure a sufficiently high ductility and maintain heal resistance to achieve a good balance among resin characteristics, it is necessary to form a single phase structure or a below-500-nm fine phase separated structure in the presence of the thermoplastic resin [B].

To confirm the existence of such a phase separated structure in the cured epoxy resin material, that is, to confirm the existence of a single phase structure or a below-500-nm fine phase separated structure formed of the amine type epoxy resin [A], the thermoplastic resin [B], and the aromatic amine [C] in cured material that is produced by curing an epoxy resin composition and has a cure degree of 90% or more as determined by DSC, a good method is to perform direct observation using any of various microscopes such as transmission electron microscope. That is to say, the decision on whether the structure formed Is a single phase structure or a below-500-nm phase separated structure can be made based on photographs taken by an appropriate microscope.

This size of a phase separated structure is defined as follows. Here, such a phase separated structure may be either a continuous two-phase structure or a sea-island structure, and a separate definition is made for each of them. First, an image that shows the phase structure is taken by an appropriate microscope. In the case of a continuous two-phase structure, five arbitrary straight lines are drawn on the image, and the intersections between the straight lines and the phase interfaces are identified. For each of the lines, 20 pairs of adjacent intersections are selected and the distances between them are measured, followed by calculating the number average of the total of 100 measurements and adopting it as the size of the phase separated structure. For a sea-island structure, 100 island phase regions are selected arbitrarily in the area contained in the image and the number average of the diameters of the island phase regions is adopted as the size of the phase separated structure. For an elliptic or Irregular shaped island phase region, the diameter of its circumscribed circle is used.

If a transmission electron microscope or a scanning: electron microscope is used here, the specimen may be dyed with osmium as required.

Such a phase separated structure has either a single phase structure or a size below 500 nm, preferably either a single phase structure or a size below 300 nm, and more preferably a single phase structure. If the phase separated structure has a size of 500 nm or more, the resulting products of fiber reinforced composite material will be likely to vary in characteristics among molding batches or among parts of the molded products or fail to have sufficiently high interlayer ductility.

Different, types of reinforcement fiber can serve for the present invention and they include glass fiber, carbon fiber, graphite fiber, aramid fiber, boron fiber, alumina fiber, and silicon carbide fiber. Two or more of these types of reinforcement fiber may be used in combination, but the use of carbon fiber and graphite fiber is preferred to provide lightweight moldings with high durability. With a high specific modulus and specific strength, carbon fiber is used favorably, particularly when it is necessary to produce lightweight or high-strength material.

In respect to carbon fiber used favorably for the present invention, virtually any appropriate type of carbon fiber can be adopted for varied uses, but it is preferable for the carbon fiber to be used to have a tensile modulus not more than 400 GPa from the viewpoint of impact resistance From the viewpoint of strength, carbon fiber with a tensile strength of 4.4 to 6.5 GPa is used preferably because composite material with high rigidity and mechanical strength can be produced. Tensile elongation is also an important factor, and it is preferable for the carbon fiber to have a high strength and a high elongation percentage of 1.7% to 2.3%. The most, suitable carbon fiber will have various good characteristics simultaneously including a tensile modulus of at least 230 GPa, tensile strength of at least 4.4 GPa, and tensile elongation of at least 1.7%.

Commercial products of carbon fiber include TORAYCA (registered trademark) T800G-24K, TORAYCA (registered trademark) T800S-24K, TORAYCA(registered trademark) T700G-24K, TORAYCA (registered trademark) T300-3K, and TORAYCA (registered trademark) T700S-12K (all manufactured by Toray Industries, Inc.).

In regard to the form and way of alignment of carbon fibers, long fibers paralleled in one direction, woven fabric, or others may be selected appropriately, but if carbon fiber reinforced composite material that is lightweight and relatively highly durable is to be obtained, it is preferable to use carbon fibers in the form of long fibers (fiber bundles) paralleled in one direction, woven fabric, or other continuous fibers. Carbon fiber bundles to be used for the present invention preferably have a monofilament fineness of 0.2 to 2.0 dtex, more preferably 0.4 to 1.8 dtex. If the monofilament fineness is less than 0.2 dtex, the carbon fiber bundles may be damaged easily due to contact with guide rollers during twining, and similar damage may take place during impregnation with the resin composition, if the monofilament fineness is more than 2.0 dtex, the resin composition may fail to impregnate carbon fiber bundles sufficiently, possibly resulting in a decrease in fatigue resistance.

The carbon fiber bundles to be used for the present invention preferably contain 2,500 to 50,000 filaments per fiber bundle, if the number of filaments is less than 2,500, the fibers may be easily caused to meander, leading to a decrease in strength. If the number of filaments is more than 50,000, resin impregnation may be difficult to perform during prepreg preparation or during molding. The number of filaments is more preferably In the range of 2,800 to 40000.

The prepreg according to the present invention is produced by impregnating the aforementioned reinforcement fiber with the aforementioned epoxy resin composition. In the prepreg, the mass fraction of fiber is preferably 40 to 90 mass %, more preferably 50 to 80 mass %. If the mass fraction of fiber is too small, the resulting composite material will be too heavy and the advantages of fiber reinforced composite material having high specific strength and specific modulus will be impaired in some cases, while if the mass fraction of fiber is too large, impregnation with the resin composition will not be achieved sufficiently and the resulting composite material will suffer from many voids, possibly leading to a large deterioration in mechanical characteristics.

There are no specific limitations on the shape of the reinforcement fiber, which may be, for example, in the form of long fibers paralleled in one direction, tow, woven fabric, mat, knit, or braid. For applications that require high specific strength and specific modulus, in particular, the most suitable is a unidirectionally paralleled arrangement of reinforcement fiber, but cloth-like (woven fabric) arrangement is also suitable for the present invention because of easy handling.

The prepreg according to the present invention can be produced by some different methods including a method in which the epoxy resin composition used as matrix resin is dissolved in a solvent such as methyl ethyl ketone and methanol to produce a solution with a decreased viscosity, and then used to impregnate reinforcement fiber (wet method), and a hot melt method in which the matrix resin is heated to decrease its viscosity and then used to impregnate reinforcement fiber (dry method).

The wet method includes the steps of immersing reinforcement fiber in a solution of epoxy resin composition, that is, matrix resin, pulling it out, and evaporating the solvent using an oven etc., whereas the hot melt method (dry method) includes the steps of heating an epoxy resin composition to reduce the low viscosity and directly impregnating the reinforcement fiber with if, or the steps of coating release paper or the like with the epoxy resin composition to prepare a film, attaching the film to cover either or both sides of a reinforcement fiber sheet, and pressing them under heat so that the reinforcement fiber is impregnated with the resin. The hot melt method is preferred for the present invention because the resulting prepreg will be substantially free of residual solvent.

The resulting prepreg sheets are stacked and the stack is heated under pressure to cure the matrix resin, thereby providing the fiber reinforced composite material according to the present invention.

Here, the application of heat and pressure is carried out by using an appropriate method such as press molding, autoclave molding, bagging molding, wrapping tape molding, and internal pressure molding.

The fiber reinforced composite material according to the present invention can be produced by a prepreg-free molding method in which reinforcement fiber is directly impregnated with the epoxy resin composition, followed by heating for curing, such as hand lay-up molding, filament winding, pultrusion, resin injection molding, and resin transfer molding. For these methods, it is preferable that two liquids, that is, a base resin formed of epoxy resin and an epoxy resin curing agent, are mixed Immediately before use to prepare an epoxy resin composition.

Fiber reinforced composite material containing the epoxy resin composition according to the present invention as matrix resin is used favorably for producing sports goods, aircraft members, and general industrial products. More specifically their preferred applications in the aerospace industry include primary structural members of aircraft such as main wing, tail unit, and floor beam; secondary structural members such as flap, aileron, cowl, fairing, and other interior materials, and structural members of artificial satellites such as rocket motor case. Of these aerospace applications, primary structural members of aircraft, including body skin and main wing skin, that particularly require high impact resistance as well as high tensile strength at low temperatures to resist the coldness during a high-altitude flight represent particularly suitable applications of the fiber reinforced composite material according to the present invention. Their preferred applications for general industrial uses include structural members of vehicles such as automobiles, ships, and railroad vehicles; and civil engineering and construction materials such as drive shafts, plate springs, windmill blades, various turbines, pressure vessels, flywheels, rollers for paper manufacture, roofing materials, cables, reinforcing bars, and mending/reinforcing materials. Applications in the spoiling goods industry include golf shafts, fishing poles, rackets for tennis, badminton, squash, etc., hockey sticks, and skiing poles.

### EXAMPLES

The epoxy resin composition according to the Invention as well as a prepreg and a fiber reinforced composite material produced therefrom are described in detail below with reference to Examples. Described below are the resin materials used in Examples and the preparation and evaluation methods used for prepreg and fiber reinforced composite materials. Preparation and evaluation of prepreg in Examples were performed in an atmosphere at a temperature of 25° C.±2° C. and relative humidity of 50% unless otherwise specified.

[Carbon Fiber (Reinforcement Fiber)]

TORAYCA (registered trademark) T800G-24K-31E(carbon fiber of 24,000 filaments, tensile strength of 5.9 GPa, tensile modulus of 294 GPa, tensile elongation of 2.0%, manufactured by Toray Industries, Inc.).

[Raw resin materials]

<Amine type epoxy resin [A]>

SUMI-EPOXY (registered trademark) ELM434 (tetraglycidyl diaminodiphenyl methane, manufactured by Sumitomo Chemical Co., Ltd.)

TG3DAS (tetraglycidyl-3,3′-diaminodiphenyl sulfone manufactured by Mitsui Fine Chemical, Inc.)

Araldite (registered trademark) MY0510 (triglycidyl-p-aminophenol, manufactured by Huntsman Japan

Araldite (registered trademark) MY0600 (triglycidyl-m-aminophenol, manufactured by Huntsman Japan KK)

GAN (N,N-diglycidyl aniline, manufactured by Nippon Kayaku Co., Ltd.)

PxGAN (N,N-diglycidyl-4-phenoxy aniline, manufactured by Toray Fine Chemicals Co., Ltd.)

DENACOL(registered trademark) Ex-731 (N-glycidylphthalmide, manufactured by Nagase ChemteX Corporation)

<Epoxy resins other than [A]>

EPON (registered trademark) 825 (bisphenol A type epoxy resin, manufactured by Momentive Specialty Chemicals)

EPICLON (registered trademark) 830 (bisphenol F type epoxy resin, manufactured by DIC)

<Thermoplastic resin [B]>

SUMIKAEXCEL (registered trademark) PES5003P (polyethersuffone, manufactured by Sumitomo Chemical Co., Ltd., weight average molecular weight: 47,000)

Virantage (registered trademark) VW-10700RP (polyethersulfone, manufactured by Solvay Speciality Polymers, weight average molecular weight: 21,000)

Virantage (registered trademark) VW-30500RP (polysulfone, manufactured by Solvay Speciality Polymers, weight average molecular weight 14,000)

PHENOTOHTO (registered trademark) YP-50 (phenoxy resin, manufactured by Nippon Steel & Sumikin Chemical Co., Ltd., weight average molecular weight: 60,000 to 80,000)

<Aromatic amine [C]>

3,3′-DDS (3, 3′-diaminodiphenyl sulfone, manufactured by Mitsui Fine Chemical, Inc.)

4,4′-DDS(4,4′-diaminophenyl sulfone, manufactured by Wakayama Seika Kogyo Co., Ltd.)

<Curing agent other than [C]>

DICY7 (dicyandiamide, manufactured by Mitsubishi Chemical Corporation)

<Thermoplastic resin particles [D]>

Grilamide (registered trademark) TR-55 particles (prepared from Grilamide (registered trademark) TR55 as input material, particles with an average particle diameter of 13 μm) (Preparation method for Grilamide (registered trademark) TR-55 particles) First, 33 g of a transparent poiyamide product (trade name: Grilamide(registered trademark) TR55, manufactured by Eraser Werke, Inc.) was added to a mixed solvent of 100 g of chloroform and 35 g of methanol to provide a uniform solution. Then, using a spray gun designed for painting, the resulting solution was sprayed strongly against the liquid surface of 1,000 g of well-stirred n-hexane so as to separate out the solute, The precipitated solid was separated by filtration, washed well with n-hexane, and vacuum-dried at a temperature of 100° C. for 24 hours to provide 28 g of white solid material. The resulting powder was observed by scanning electron microscopy and found to be particles of Grilamide (registered trademark) TR-55 with an average particle diameter of 13 μm.

Orgasol (registered trademark) 1002D (manufactured by ATOCHEM, average particle diameter: 21.0 Mm)

<Other components >

DCMU99 (3-(3,4-dichlorophenyl)-1,1-dimethylurea, curing accelerator, manufactured by Hodogaya Chemical Co., Ltd.)

(1) Preparation of epoxy resin composition In a kneader, required quantities of the amine type epoxy resin [A] or an epoxy resin other than [A] and the thermoplastic resin [B] were fed and heated to 160° C. while kneading, followed by additional kneading at 180° C. for 1 hour to produce a transparent viscous liquid. After cooling to 80° C. while kneading, required quantities of the aromatic amine [C] or a curing agent other than [C], the thermoplastic resin particles [D], and other components were added and kneaded further to produce an epoxy resin composition.

(2) Measurement of DSC cure degree of cured resin

From the epoxy resin composition prepared in paragraph (1) above, a 5 mg specimen was taken and subjected to DSC measurement white heating the specimen from 30° C. to 350° C. at a heating rate of 10° C./min to provide an exotherm curve, followed by integrating the exothermic peak to calculate the gross calorific value QT of the epoxy resin composition.

The epoxy resin composition prepared in paragraph (1) above was deaerated in a vacuum and cured for 2 hours at a temperature of 180° C. to provide cured resin material . From the resulting cured resin material a 5 mg specimen was taken and subjected to DSC measurement while heating the sample from 30° C. to 35° C. at a heating rate of 10° C./min to provide an exotherm curve, if a residual exothermic peak exists, the exothermic peak Is integrated to calculate the residual calorific value QR. If no residual exothermic peak exists, it was assumed that QR=0.

Here, the cure degree (%) determined by DSC is calculated as follows:

cure degree (%)=(QT-QR)/QT×100.

(3) Observation of phase structure in cured resin material

The epoxy resin composition prepared in paragraph (1) above was deaerated in a vacuum and cured for 2 hours at a temperature of 18° C. to provide cured resin material. The cured resin was sliced into a thin section, and examined by transmission electron microscopy (TEM) under the following conditions to provide a transmission electron microscopic image. No dyeing agent was used.

Equipment: H-7100 transmission electron microscope (manufactured by Hitachi, Ltd )

Accelerating voltage: 100 kV

Magnification: 10.000 times

The transmission electron microscopic image obtained was examined to determine whether there was a phase separated structure with a size in the range from several tens of nanometers to several tens of micrometers. Here, any structure formed of the thermoplastic resin particles [D] insoluble In the epoxy resin was not regarded as such a phase structure, and observation was performed only for phase separated structures attributable to the epoxy resin composition excluding the thermoplastic resin particles [D]. To determine whether or not a dispersed phase found was attributable to the thermoplastic resin particles [D]. the thermoplastic resin particles [D] in the epoxy resin composition were observed by scanning electron microscopy and compared in terms of size and morphology.

Phase separated structures in cured resin material can be in the form of a continuous two-phase structure or a sea-island structure and accordingly, their measurements were made as follows. In Tables 1 and 2, the size of the phase separated structures in cured resin material is shown in the column of “Phase structure (nm)”. When a single phase structure is found, it Is indicated as “single phase”.

First, an image that shows a phase structure is taken by transmission electron microscopy. In the case of a continuous two-phase structure, five arbitrary straight lines were drawn on the image, and the adjacent intersections between the straight lines and the phase interfaces were identified. For each of the lines, 20 pairs of adjacent intersections were selected and the distances between them were measured, followed by calculating the number average of the total of 100 measurements and adopting it as the size of the phase separated structure. For a sea-Island structure, 100 island phase regions were selected arbitrarily in the area contained in the image and the number average of the diameters of the island phase regions was adopted as the size of the phase separated structure, For an elliptic or irregular shaped island phase region, the diameter of its circumscribed circle was used.

(4) Measurement of bending deflection of cured resin material

The epoxy resin composition prepared in paragraph (1) above was deaerated in a vacuum and injected in a mold which was set up so that the thickness would be 2 mm. Curing was performed at a temperature of 180° C. for 2 hours to provide cured resin with a thickness of 2 mm. Then, the resulting cured resin plate was cut to prepare a test piece with a width of 10 mm and length of 60 mm, and it was subjected to three-point bending test with a span of 32 mm, followed by determining the bending deflection, which represents the resin elongation, according to JIS K7171-1994.

(5) Measurement of glass transition temperature and rubber state elastic modulus of cured resin material From the cured resin material plate prepared in paragraph (4), a test piece with a width of 10 mm and a length of 40 mm was cut out and the test piece was set to the solid twisting jig in a dynamic viscoelasticity measuring apparatus (ARES, manufactured by TA Instruments) and subjected to measurement over the temperature range from 30° C. to 300° C. under the conditions of a heating rate of 5° C./min. a frequency of 1 Hz. and a strain of 0.1%. In doing so, the glass transition temperature was assumed to be the temperature where the tangent drawn in the glass region and the tangent drawn in the glass transition region intersect each other in the graph between storage elastic modulus and temperature obtained above. The rubber state elastic modulus was assumed to be the storage elastic modulus at a temperature 50° C. higher than the glass transition temperature In the graph between storage elastic modulus and temperature obtained above. Here, if there occurred a plurality of glass transition temperatures that were attributable to [A], [B], or [C] instead of the thermoplastic resin particles [D] insoluble ;n the epoxy resin, the lowest one was adopted as the glass transition temperature.

(6) Preparation of prepreg

The epoxy resin composition was spread over a piece of release paper with a knife coater to prepare a resin film, then, carbon fibers of TORAYCA (registered trademark) T800G-24K-31E manufactured by Toray Industries, inc. were paralleled in one direction to form a sheet, and two resin films were used to cover both sides of the carbon fiber sheet and pressed under heat to impregnate the carbon fiber sheet with the resin to provide a unidirectional prepreg sheet with a carbon fiber metsuke of 190 g/m² and a matrix resin mass fraction of 35.5%. Here, in cases where an epoxy resin composition containing the thermoplastic resin particles [D] was used, two-step impregnation was carried out as described below to produce prepreg sheets in which the thermoplastic resin particles [D] were highly localized near the surface.

First, primary prepreg that was free of the thermoplastic resin particles [P] was prepared. Of the component materials listed in Tables 1 and 2, an epoxy resin composition free of the thermoplastic resin particles [D] was prepared by the procedure described in paragraph (1) above. This epoxy resin composition for primary prepreg was spread over a piece of release paper with a knife coater to provide a resin film for primary prepreg with a metsuke of 30 g/m², which corresponds to 80 mass % of the normal value. Then, carbon fibers of TORAYCA (registered trademark) T800G-24K.-31E manufactured by Toray Industries, Inc. were paralleled in one direction to form a sheet, and two of the resin films for primary prepreg were used to cover both sides of the carbon fiber sheet and pressed under heat using heating rollers at a temperature of 100° C. and an air pressure of 1 atm to impregnate the carbon fiber sheet with the resin to provide primary prepreg.

To prepare resin films for two-step impregnation, the procedure described in paragraph (1) above was carried out by using a kneader to produce an epoxy resin composition containing the thermoplastic resin particles [D] insoluble in epoxy resin, which is among the component materials listed in Tables 1 and 2, in a quantity 2.5 times the specified value. This epoxy resin composition for two-step impregnation was spread over a piece of release paper with a knife coater to provide a resin film for two-step impregnation with a metsuke of 20 g/m², which corresponds to 40 mass % of the normal value. Such films were used to sandwich a primary prepreg sheet and pressed under heal using heating rollers at a temperature of 80° C. and an air pressure of 1 atm to provide a prepreg sheet in which the thermoplastic resin particles [D] were highly localized near the surface.

(7) Preparation of composite material plate for Mode-1 interlaminar toughness (G_{IC}) test and implementation of G_{IC} measurement

By the following procedure from (a) to (e), plates of composite material for G_{IC} test were prepared according to JIS K7086 (1993).

(a) A total of 20 unidirectional prepreg plies as prepared in paragraph (6) were laminated together with the fibers aligned in one direction. A fluorine resin film with a width of 40 mm and a thickness of 12.5 μm was interposed at the center of the laminate (between the 10th ply and the 11th ply) in such a manner that its direction was perpendicular to the aligned fibers.

(b) The laminated prepreg plies were covered with a nylon film without leaving gaps, and molded in an autoclave under the conditions of 2 hours at a temperature of 180° C., a pressure of 0.59 MPa, and a heating rate of 1.5° C./min to form unidirectional fiber reinforced composite material.

(c) The unidirectional fiber reinforced composite material obtained in step (b) was cut to a width of 20 mm and a length of 195 mm. Cutting was performed so that the fibers were parallel to the length direction of the specimen.

(d) According to JIS K7086 (1993), a block (aluminum, length 25 mm) for pin load application was attached to an end (where the film was located) of the specimen.

(e) White paint was applied to both side faces of the specimen to ensure easy observation of the propagation of cracking.

The composite material plate prepared above was used to make G_{IC} measurements by the following procedure.

Test was carried out using an Instron type universal tester (manufactured by Instron Corporation) according to Appendix 1 of JIS K7086 (1993). The crosshead speed was 0.5 mm/min before the length of the crack reached 20 mm and 1 mm/min after it reached 20 mm. According to JIS K7086 (1993), the Mode-I inferlaminar fracture toughness (G_{IC} at the initial point of cracking) that corresponds to the critical load at the initial point of cracking and the Mode-I interlaminar fracture toughness during progress of cracking were calculated from the load, displacement, and crack length. A G_{IC} measurement at the initial point of cracking and five or more measurements made at crack lengths of 10 mm to 60 mm. that is, a total of six of more measurements, were averaged and used as G_{IC} for comparison.

(3) Measurement of compression strength of fiber reinforced composite material A total of 12 unidirectional prepreg plies prepared in paragraph (8) were laminated with their fibers aligned parallel to the compression direction, and the stack of prepreg piles was covered with a nylon film without leaving gaps and heated in an autoclave for 2 hours at a temperature of 18° C. under the conditions of a pressure of 0.59 MPa and a heating rate of 1.5° C./min to provide a laminate body. From this laminate body, a tabbed specimen with a thickness of 2 mm, a width of 15 mm, and a length 78 mm was prepared This specimen was subjected to 0° compression strength measurement using an Instron type universal tester according to JIS K7076 (1991). Five specimens were used (n=5). Here, the compression strength in a high temperature environment was measured at a temperature of 140+ C. using an instron type universal tester equipped with a temperature controlled bath.

### Example 1

Using a kneading machine, 20 parts by mass of TG3DAS (amine type epoxy resin [A]) and 80 pasts by mass of EPON (registered trademark) 825 (epoxy resin other than [A]) were kneaded, and then 21 parts by mass of SUMIKAEXCEL (registered trademark) PES5003P (thermoplastic resin [B]) was dissolved and kneaded at 160° C. After cooling the epoxy resin composition to 80° C. 69 parts by mass of 4,4′-DDS (aromatic amine [C]) and 28 parts by mass of Grilamide (registered trademark) TR-55 particles (thermoplastic resin particles [D]) were kneaded to provide an epoxy resin composition, Table 1 lists the components and proportions (figures in Table 1 are in parts by mass). Using the resulting epoxy resin composition, (2) measurement of DSC cure degree of cured resin, (3) observation of phase structure in cured resin material, (4) measurement of bending deflection of cured resin material, and (5) measurement of glass transition temperature and rubber state elastic modulus of cured resin material were performed. Then, prepreg was prepared from the resulting epoxy resin composition according to the procedure described in paragraph (6). Using the resulting prepreg, (7) preparation of composite material plate for Made-I interlaminar toughness (G_{IC}) test and implementation of G_{IC} measurement and (8) measurement of compression strength of fiber reinforced composite material were performed. Results are shown in Tables 1-1.

### Examples 2 to 14 and Comparative Examples 1 to 9

Except for using the amine type epoxy resin [A] or epoxy resin other than [A], the thermoplastic resin [B], the aromatic amine [C] or a curing agent other than [C], the thermoplastic resin particles [D], and other components in quantities as shown in Table 1, the same procedure as in Example 1 was carried out to produce an epoxy resin composition and prepreg. Using the resulting epoxy resin composition, (2) measurement of DSC cure degree of cured resin, (3) observation of phase structure in cured resin material, (4) measurement of bending deflection of cured resin material, and (5) measurement of glass transition temperature and rubber state elastic modulus of cured resin material were performed. Using the resulting prepreg, (7) preparation of composite material plate for Mode-I interlaminar toughness (G_{IC}) test and implementation of G_{IC} measurement and (8) measurement of compression strength of fiber reinforced composite material were performed. Results obtained In Examples 2 to 3 are shown in Table 1-1, those in Examples 9 to 14 shown in Table 1-2, and those in Comparative examples 1 to 9 shown in Table 2.

### Examples 15 and 16 and Comparative examples 10 and 11

Except for using the amine type epoxy resin [A] or epoxy resin other than [A], the thermoplastic resin [B], and the aromatic amine [C] in quantities as shown in Tables 1 and 2. the same procedure as in Example 1was carried out to produce an epoxy resin composition and prepreg Using the resulting epoxy resin composition, (2) measurement of DSC cure degree of cured resin, (3) observation of phase structure in cured resin material, (4) measurement of bending deflection of cured resin material, and (5) measurement of glass transition temperature and rubber state elastic modulus of cured resin material were performed. Using the resulting prepreg, (7) preparation of composite material plate for Mode-I interlaminar toughness (G_{IC}.) test and implementation of G_{IC} measurement and (8) measurement of compression strength of fiber reinforced composite material were performed. Results obtained in Examples 15 and 16 are shown in Table 1-2, and those obtained in Comparative examples 10 and 11 are shown in Table 2.

TABLE 1

| | Example 1 | Example 2 | Example 3 | Example 4 |
|---|---|---|---|---|
| Amine type epoxy resin [A] (parts by mass) | | | | |
| Sumiepoxy ® ELM434 | | | | |
| TG3DAS | 20 | 20 | | 30 |
| Araldite ® MY0510 | | | | |
| Araldite ® MY0600 | | | 60 | |
| GAN | | | | 10 |
| PxGAN | | | | |
| DENACOL ® Ex-731 | | | | |
| Epoxy resin other than [A] (parts by mass) | | | | |
| EPON ® 825 | 80 | 80 | | 60 |
| EPICLON ® 830 | | | 40 | |
| Thermoplastic resin [B] (parts by mass) | | | | |
| SUMIKAEXCEL ® PES5003P | 21 | | | |
| Virantage ® VW-10700RP | | | 19 | 17 |
| Virantage ® VW-30500RP | | | | |
| PHENOTOHTO ® YP-50 | | 15 | | |
| Aromatic amine [C] (parts by mass) | | | | |
| 3,3′-DDS | | | | |
| 4,4′-DDS | 69 | 69 | 88 | 56 |
| (Curing agent other than [C]) (parts by mass) | | | | |
| DICY7 | | | | |
| Thermoplasticity particles [D] (parts by mass) | | | | |
| Grilamide ® TR-55 particles | 28 | 27 | 30 | 25 |
| Orgasol ® 1002D | | | | |
| Other component (parts by mass) | | | | |
| DCMU99 | | | | |
| Number of Moles of active hydrogen/number | 1.8 | 1.8 | 1.7 | 1.5 |
| of moles of epoxy groups | | | | |
| Content of thermoplastic resin [B] in epoxy | 11 | 8 | 9 | 10 |
| resin composition excluding [D] (mass %) | | | | |
| Characteristics of cured resin material | | | | |
| DSC cure degree (%) | 100 | 97 | 100 | 100 |
| phase structure | single phase | 460 nm | single phase | single phase |
| | | sea-island | | |
| | | structure | | |
| bending deflection quantity (mm) | 6.2 | 6.6 | 5.8 | 6.9 |
| glass transition temperature X (° C.) | 173 | 161 | 182 | 179 |
| rubber stated elastic modulus Y (MPa) | 2.8 | 3.0 | 7.1 | 4.8 |
| Equation (1) 0.19X/° C. − 31.5 ≦ Y/MPa ≦ | 1.4 ≦ Y ≦ 5.9 | −0.9 ≦ Y ≦ 3.6 | 3.1 ≦ Y ≦ 7.6 | 2.5 ≦ Y ≦ 7.0 |
| 0.19 X/° C. − 27 | | | | |
| Characteristics of carbon fiber reinforced | | | | |
| composite material | | | | |
| G_{IC} (J/m²) | 480 | 430 | 490 | 540 |
| 0° compression strength (25° C.) (MPa) | 1630 | 1510 | 1680 | 1650 |
| 0° compression strength (140° C.) (MPa) | 1240 | 1180 | 1360 | 1240 |

| | Example 5 | Example 6 | Example 7 | Example 8 |
|---|---|---|---|---|
| Amine type epoxy resin [A] (parts by mass) | | | | |
| Sumiepoxy ® ELM434 | | | | 30 |
| TG3DAS | 40 | | | |
| Araldite ® MY0510 | | 45 | 45 | |
| Araldite ® MY0600 | | | | |
| GAN | 20 | | | 70 |
| PxGAN | | | | |
| DENACOL ® Ex-731 | 10 | | | |
| Epoxy resin other than [A] (parts by mass) | | | | |
| EPON ® 825 | | 55 | 55 | |
| EPICLON ® 830 | 30 | | | |
| Thermoplastic resin [B] (parts by mass) | | | | |
| SUMIKAEXCEL ® PES5003P | | | | |
| Virantage ® VW-10700RP | 19 | 24 | | 75 |
| Virantage ® VW-30500RP | | | 15 | |
| PHENOTOHTO ® YP-50 | | | | |
| Aromatic amine [C] (parts by mass) | | | | |
| 3,3′-DDS | 45 | | | |
| 4,4′-DDS | | 72 | 72 | 39 |
| (Curing agent other than [C]) (parts by mass) | | | | |
| DICY7 | | | | |
| Thermoplasticity particles [D] (parts by mass) | | | | |
| Grilamide ® TR-55 particles | 24 | 29 | 27 | 31 |
| Orgasol ® 1002D | | | | |
| Other component (parts by mass) | | | | |
| DCMU99 | | | | |
| Number of Moles of active hydrogen/number | 1.2 | 1.5 | 1.5 | 1.1 |
| of moles of epoxy groups | | | | |
| Content of thermoplastic resin [B] in epoxy | 12 | 12 | 8 | 35 |
| resin composition excluding [D] (mass %) | | | | |
| Characteristics of cured resin material | | | | |
| DSC cure degree (%) | 98 | 100 | 98 | 98 |
| phase structure | single phase | single phase | 300 nm | 100 nm |
| | | | sea-island | sea-island |
| | | | structure | structure |
| bending deflection quantity (mm) | 7.5 | 6.7 | 6.1 | 8.1 |
| glass transition temperature X (° C.) | 185 | 182 | 176 | 164 |
| rubber stated elastic modulus Y (MPa) | 5.9 | 4.0 | 5.3 | 3.5 |
| Equation (1) 0.19X/° C. − 31.5 ≦ Y/MPa ≦ | 3.7 ≦ Y ≦8.2 | 3.1 ≦ Y ≦ 7.6 | 1.8 ≦ Y ≦ 6.3 | −0.3 ≦ Y ≦ 4.2 |
| 0.19 X/° C. − 27 | | | | |
| Characteristics of carbonfiber reinforced | | | | |
| composite material | | | | |
| G_{IC} (J/m²) | 570 | 530 | 500 | 620 |
| 0° compression strength (25° C.) (MPa) | 1670 | 1640 | 1670 | 1540 |
| 0° compression strength (140° C.) (MPa) | 1480 | 1290 | 1230 | 1250 |

| | Example 9 | Example 10 | Example 11 | Example 12 |
|---|---|---|---|---|
| Amine type epoxy resin [A] (parts by mass) | | | | |
| Sumiepoxy ® ELM434 | | | 40 | 70 |
| TG3DAS | | 40 | | |
| Araldite ® MY0510 | | 40 | | |
| Araldite ® MY0600 | 50 | | | |
| GAN | | | | 30 |
| PxGAN | | | | |
| DENACOL ® Ex-731 | | | | |
| Epoxy resin other than [A] (parts by mass) | | | | |
| EPON ® 825 | 25 | | | |
| EPICLON ® 830 | 25 | 20 | 60 | |
| Thermoplastic resin [B] (parts by mass) | | | | |
| SUMIKAEXCEL ® PES5003P | | | | |
| Virantage ® VW-10700RP | 42 | 17 | 53 | 33 |
| Virantage ® VW-30500RP | | | | |
| PHENOTOHTO ® YP-50 | | | | |
| Aromatic amine [C] (parts by mass) | | | | |
| 3,3′-DDS | | 52 | | |
| 4,4′-DDS | 67 | | 58 | 59 |
| (curing agent other than [C]) (parts by mass) | | | | |
| DICY7 | | | | |
| Thermoplasticity particles [D] (parts by mass) | | | | |
| Grilamide ® TR-55 particles | 31 | | 31 | 28 |
| Orgasol ® 1002D | | 25 | | |
| Other component (parts by mass) | | | | |
| DCMU99 | | | | |
| Number of moles of active hydrogen/number | 1.4 | 1.1 | 1.4 | 1.3 |
| of moles of epoxy groups | | | | |
| Content of thermoplastic resin [B] in epoxy | 20 | 10 | 25 | 17 |
| resin composition excluding [D] (mass %) | | | | |
| Characteristics of cured resin material | | | | |
| DSC cure degree (%) | 100 | 96 | 100 | 100 |
| phase structure | single phase | single phase | single phase | single phase |
| bending deflection quantity (mm) | 7.9 | 5.8 | 8.2 | 7.0 |
| glass transition temperature X (° C.) | 186 | 194 | 180 | 204 |
| rubber state elastic modulus Y (MPa) | 5.1 | 9.4 | 5.4 | 8.3 |
| Equation (1): 0.19X/° C. − 31.5 ≦ Y/MPa ≦ | 3.8 ≦ Y ≦ 8.3 | 5.4 ≦ Y ≦ 9.9 | 2.7 ≦ Y ≦ 7.2 | 7.3 ≦ Y ≦ 11.8 |
| 0.19X/° C. − 27 | | | | |
| Characteristics of carbon fiber reinforced composite material | | | | |
| G_{IC} (J/m²) | 590 | 540 | 530 | 540 |
| 0° compression strength (25° C.) (MPa) | 1650 | 1780 | 1620 | 1760 |
| 0° compression strength (140° C.) (MPa) | 1240 | 1400 | 1200 | 1520 |

| | Example 13 | Example 14 | Example 15 | Example 16 |
|---|---|---|---|---|
| Amine type epoxy resin [A] (parts by mass) | | | | |
| Sumiepoxy ® ELM434 | 30 | 30 | | |
| TG3DAS | | | 30 | |
| Araldite ® MY0510 | 50 | 50 | | |
| Araldite ® MY0600 | | | | 40 |
| GAN | 20 | 20 | | |
| PxGAN | | | | |
| DENACOL ® Ex-731 | | | | |
| Epoxy resin other than [A] (parts by mass) | | | | |
| EPON ® 825 | | | | |
| EPICLON ® 830 | | | 70 | 60 |
| Thermoplastic resin [B] (parts by mass) | | | | |
| SUMIKAEXCEL ® PES5003P | | | | |
| Virantage ® VW-10700RP | 42 | 40 | 39 | 68 |
| Virantage ® VW-30500RP | | | | |
| PHENOTOHTO ® YP-50 | | | | |
| Aromatic amine [C] (parts by mass) | | | | |
| 3,3′-DDS | 69 | 58 | | |
| 4,4′-DDS | | | 75 | 60 |
| (curing agent other than [C]) (parts by mass) | | | | |
| DICY7 | | | | |
| Thermoplasticity particles [D] (parts by mass) | | | | |
| Grilamide ® TR-55 particles | 31 | 29 | | |
| Orgasol ® 1002D | | | | |
| Other component (parts by mass) | | | | |
| DCMU99 | | | | |
| Number of moles of active hydrogen/number | 1.3 | 1.1 | 2.0 | 1.3 |
| of moles of epoxy groups | | | | |
| Content of thermoplastic resin [B] in epoxy | 20 | 20 | 18 | 30 |
| resin composition excluding [D] (mass %) | | | | |
| Characteristics of cured resin material | | | | |
| DSC cure degree (%) | 100 | 100 | 100 | 100 |
| phase structure | single phase | 200 nm | single phase | single phase |
| | | sea-island | | |
| | | structure | | |
| bending deflection quantity (mm) | 8.3 | 6.5 | 6.6 | 8.8 |
| glass transition temperature X (° C.) | 195 | 190 | 163 | 179 |
| rubber state elastic modulus Y (MPa) | 8.8 | 8.8 | 1.9 | 5.7 |
| Equation (1): 0.19X/° C. − 31.5 ≦ Y/MPa ≦ | 5.6 ≦ Y ≦ 10.1 | 4.6 ≦ Y ≦ 9.1 | −0.5 ≦ Y ≦ 4.0 | 2.5 ≦ Y ≦ |
| 0.19X/° C. − 27 | | | | 7.0 |
| Characteristics of carbon fiber reinforced composite material | | | | |
| G_{IC} (J/m²) | 600 | 580 | 320 | 440 |
| 0° compression strength (25° C.) (MPa) | 1700 | 1680 | 1610 | 1590 |
| 0° compression strength (140° C.) (MPa) | 1450 | 1460 | 1240 | 1150 |

TABLE 2

| | Comparative | Comparative | Comparative | Comparative | Comparative | Comparative |
|---|---|---|---|---|---|---|
| | example 1 | example 2 | example 3 | example 4 | example 5 | example 6 |
| Amine type epoxy resin [A] (parts by mass) | | | | | | |
| SUMI-EPOXY ® ELM434 | | | | | | |
| TG3DAS | | 55 | | | | |
| Araldite ® MY0510 | | | | 40 | 50 | 65 |
| Araldite ® MY0600 | | | 80 | | | |
| GAN | | | | | | |
| PxGAN | | | | | | |
| DENACOL ® Ex-731 | | | | | | |
| Epoxy resin other than [A] (parts by mass) | | | | | | |
| EPON ® 825 | 70 | | 20 | | | |
| EPICLON ® 830 | 30 | 45 | | 60 | 60 | 35 |
| Thermoplastic resin [B] (parts by mass) | | | | | | |
| SUMIKAEXCEL ® PES5003P | | | | | | |
| Virantage ® VW-10700RP | 74 | | 27 | 53 | 50 | 53 |
| Virantage ® VW-30500RP | | | | | | |
| PHENOTOHTO ® YP-50 | | | | | | |
| Aromatic amine [C] (parts by mass) | | | | | | |
| 3,3′-DDS | | | | | | |
| 4,4′-DDS | 72 | | | | | |
| (curing agent other than [C]) (parts by mass) | | 45 | | 46 | 49 | 53 |
| DICY7 | | | | | | |
| Thermoplasticity particles [D] (parts by mass) | | | 11 | | | |
| Grilamide ® TR-55 particles | | | | | | |
| Orgasol ® 1002D | 36 | 21 | 21 | 29 | 29 | 30 |
| Other component (parts by mass) | | | | | | |
| DCMU99 | | | | | | |
| Number of moles of active hydrogen/number | 2.0 | 1.1 | 1.0 | 1.0 | 1.0 | 1.0 |
| of moles of epoxy groups | | | | | | |
| Content of thermoplastic resin [B] in epoxy | 30 | 0 | 19 | 27 | 25 | 26 |
| resin composition excluding [D] (mass %) | | | | | | |
| Characteristics of cured resin material | | | | | | |
| DSC cure degree (%) | 100 | 99 | 97 | 99 | 98 | 97 |
| phase structure | single phase | single phase | single phase | single phase | single phase | single phase |
| bending deflection quantity (mm) | 12.0 | 2.5 | 3.2 | 4.9 | 4.5 | 4.0 |
| glass transition temperature X (° C.) | 130 | 178 | 188 | 167 | 175 | 190 |
| rubber state elastic modulus Y (MPa) | 2.2 | 11.2 | 12.3 | 9.9 | 11.4 | 14.2 |
| Equation (1): 0.19X/° C. − 31.5 ≦ Y/MPa ≦ | −6.8 ≦ Y ≦ −2.3 | 2.3 ≦ Y ≦ 6.8 | 4.2 ≦ Y ≦ 8.7 | 0.2 ≦ Y ≦ 4.7 | 1.8 ≦ Y ≦ 6.3 | 4.6 ≦ Y ≦ 9.1 |
| 0.19X/° C. − 27 | | | | | | |
| Characteristics of carbon fiber reinforced | | | | | | |
| composite material | | | | | | |
| G_{IC} (J/m²) | 730 | 260 | 290 | 420 | 400 | 390 |
| 0° compression strength (25° C.) (MPa) | 1420 | 1830 | 1590 | 1620 | 1630 | 1660 |
| 0° compression strength (140° C.) (MPa) | 850 | 1380 | 1210 | 1120 | 1130 | 1140 |

| | Comparative | Comparative | Comparative | Comparative | Comparative |
|---|---|---|---|---|---|
| | example 7 | example 8 | example 9 | example 10 | example 11 |
| Amine type epoxy resin [A] (parts by mass) | | | | | |
| SUMI-EPOXY ® ELM434 | 30 | 20 | | 60 | |
| TG3DAS | | | 40 | | |
| Araldite ® MY0510 | 50 | | | | 100 |
| Araldite ® MY0600 | | | | | |
| GAN | 20 | 30 | | | |
| PxGAN | | | 40 | | |
| DENACOL ® Ex-731 | | | | 50 | |
| Epoxy resin other than [A] (parts by mass) | | | | | |
| EPON ® 825 | | | 20 | | |
| EPICLON ® 830 | | 50 | | | |
| Thermoplastic resin [B] (parts by mass) | | | | | |
| SUMIKAEXCEL ® PES5003P | | | 11 | 10 | |
| Virantage ® VW-10700RP | 37 | 20 | | | |
| Virantage ® VW-30500RP | | | | | 117 |
| PHENOTOHTO ® YP-50 | | | | | |
| Aromatic amine [C] (parts by mass) | | | | | |
| 3,3′-DDS | | | | | |
| 4,4′-DDS | 48 | | | | |
| (curing agent other than [C]) (parts by | | 81 | 49 | 45 | 75 |
| mass) | | | | | |
| DICY7 | | | | | |
| Thermoplasticity particles [D] (parts by | | | | | |
| mass) | | | | | |
| Grilamide ® TR-55 particles | 27 | 30 | 20 | | |
| Orgasol ® 1002D | | | | | |
| Other component (parts by mass) | | | | | |
| DCMU99 | | | | | |
| Number of moles of active hydrogen/number | 0.9 | 2.2 | 1.2 | 1.1 | 1.2 |
| of moles of epoxy groups | | | | | |
| Content of thermplastic resin [B] in epoxy | 20 | 10 | 7 | 6 | 40 |
| resin composition excluding [D] (mass %) | | | | | |
| Characteristics of cured resin material | | | | | |
| DSC cure degree (%) | 100 | — | 98 | 97 | 94 |
| phase structure | 700 nm | — | single phase | single phase | 1 μm |
| | sea-island | | | | sea-island |
| | struciure | | | | structure |
| bending deflection quantity (mm) | 4.2 | — | 4.6 | 4.0 | 3.9 |
| glass transition temperature X (° C.) | 180 | — | 170 | 173 | 169 |
| rubber state elastic modulus Y (MPa) | 12.2 | — | 7.7 | 9.7 | 6.2 |
| Equation (1): 0.19X/° C. − 31.5 ≦ Y/MPa ≦ | 2.7 ≦ Y ≦ 7.2 | — | 0.8 ≦ Y ≦ 5.3 | 1.4 ≦ Y ≦ 5.9 | 0.6 ≦ Y ≦ 5.1 |
| 0.19X/° C. − 27 | | | | | |
| Characteristics of carbon fiber reinforced | | | | | |
| composite material | | | | | |
| G_{IC} (J/m²) | 530 | — | 260 | 170 | 360 |
| 0° compression strength (25° C.) (MPa) | 1560 | — | 1690 | 1630 | 1650 |
| 0° compression strength (140° C.) (MPa) | 1370 | — | 1350 | 1140 | 1240 |

Comparison between Examples 1 to 16 and Comparative examples 1 to 11 reveals that the cured resin material according to the present invention show resin elongation and heat resistance and that the fiber reinforced composite material is high in G_{IC} and in 0° compression strength at high temperatures.

Comparison between Examples 1 to 16 and Comparative example 1 reveals that even in the case where the thermoplastic resin [B] and the aromatic amine [C] are contained in required quantities and where at the same time, the number of moles of active hydrogen contained in [C] is 1.05 to 2.0 times as large as the number of moles of epoxy groups contained in the entire epoxy resin composition, the absence of the amine type epoxy resin [A] causes the glass transition temperature and the rubber state elastic modulus to fall to meet the relation 0.19X/° C.-31.5≦Y/MPa≦0.19X/° C.-27 (where X denotes the glass transition temperature (° C.) and Y denotes the rubber state elastic modulus (MPa)), resulting particularly in fiber reinforced composite material with decreased 0° compression strength at high temperatures.

Comparison between Examples 1 to 16 and Comparative example 2 reveals that even in the case where the amine type epoxy resin [A] and the aromatic amine [C] are contained in required quantities and where at the same time, the number of motes of active hydrogen contained in [C] is 1.05 to 2.0 times as large as the number of moles of epoxy groups contained In the entire epoxy resin composition, the absence of the thermoplastic resin [B] in required quantities causes the glass transition temperature and the rubber state elastic modulus to fall to meet the relation 0.19X/° C.-31.5≦Y/MPa≦0.19X/° C.-27 (where X denotes the glass transition temperature (° C.) and Y denotes the rubber state elastic modulus (MPa)), resulting particularly in fiber reinforced composite material with decreased G_{IC}.

Comparison between Examples 1 to 16 and Comparative example 3 reveals that even in the case where the amine type epoxy resin [A] and a required quantify of the thermoplastic resin [B] are contained, the absence of the aromatic amine [C] causes the glass transition temperature and the rubber state elastic modulus to fail to meet the relation 0.19X/° C.-31.5≦Y/MPa≦0.19X/° C.-27 (where X denotes the glass transition temperature (° C.) and Y denotes the rubber state elastic modulus (MPa)), resulting particularly in fiber reinforced composite material with decreased G_{IC}.

Comparison between Example 6 and Comparative examples 4 to 6 reveals that even in the case where the amine type epoxy resin [A], a required quantity of the thermoplastic resin [B], and the aromatic amine [C] are contained, a state where the number of moles of active hydrogen contained in [C] is less than 1.05times as large as the number of moles of epoxy groups contained in the entire epoxy resin composition and where at the same time the phase separated structure is a single phase structure causes the glass transition temperature and the rubber state elastic modulus to fail to meet the relation 0.19X/° C.-31.5≦Y/MPa≦0.19X/° C.-27 (where X denotes the glass transition temperature (° C.) and Y denotes the rubber state elastic modulus (MPa)), resulting particularly in fiber reinforced composite material with decreased G_{IC}.

Comparison between Examples 13 and 14 and Comparative example 7 reveals that in the case where the amine type epoxy resin [A], a required quantity of the thermoplastic resin [B], and the aromatic amine [C]are contained, but the number of moles of active hydrogen contained In [C] is less than 1.05 times as large as the number of moles of epoxy groups contained in the entire epoxy resin composition, and the phase separated structure is has a size of 500 nm or more, the glass transition temperature and the rubber state elastic modulus fail to meet the relation 0.19X/° C.-31.5≦Y/MPa≦0.19X/° C.-27 (where X denotes the glass transition temperature (° C.) and Y denotes the rubber state elastic modulus (MPa)), resulting in fiber reinforced composite material with decreased G_{IC} and decreased 0° compression strength at normal temperature.

Comparison between Examples 1 to 16 and Comparative example 8 reveals that in the case where the amine type epoxy resin [A], a required quantity of the thermoplastic resin [B], and the aromatic amine [C] are contained, but the number of moles of active hydrogen contained in [C] is more than 2.0 times as large as the number of moles of epoxy groups contained in the entire epoxy resin composition, the epoxy resin composition was too high in viscosity, failing to prepare an epoxy resin composition.

Comparison between Examples 1 to 16 and Comparative examples 9 and 10 reveals that in the case where the amine type epoxy resin [A], the thermoplastic resin [B], and the aromatic amine [C] are contained and in addition, the number of moles of active hydrogen contained in [C] is 1.05 to 2.0 times as large as the number of moles of epoxy groups contained in the entire epoxy resin composition, but the thermoplastic resin [B] fails to account for 8 to 40 mass % of the epoxy resin composition, the glass transition temperature and the rubber state elastic modulus fail to meet the relation 0.19X/° C.-31.5≦Y/MPa≦0.19X/° C.-27 (where X denotes the glass transition temperature (° C.) and Y denotes the rubber state elastic modulus (MPa)), resulting particularly in fiber reinforced composite material with decreased G_{IC}.

Comparison between Example 18 and Comparative example 11 reveals that in the case where the amine type epoxy resin [A], a required quantity of the thermoplastic resin [B], and the aromatic amine [C] are contained and in addition, the number of moles of active hydrogen contained in [G] is 1.05 to 2.0 times as large as the number of moles of epoxy groups contained in the entire epoxy resin composition, but [A], [B], and [C] form a coarse sea-island structure with a size of 1 μm, the glass transition temperature and the rubber state elastic modulus fail to meet the relation 0.19X/° C.-31.5≦Y/MPa≦0.19X/° C.-27 (where X denotes the glass transition temperature (° C.) and Y denotes the rubber state elastic modulus (MPa)), resulting in fiber reinforced composite material with decreased G_{IC}.

### INDUSTRIAL APPLICABILITY

The present invention serves to provide an epoxy resin composition having an improved resin elongation percentage and heat resistance. Such an epoxy resin composition serves to produce fiber reinforced composite material that is high in compression strength and interlaminar toughness and accordingly suitable particularly for manufacturing structural members. Their preferred applications in the aerospace industry include, for instance, primary structural members of aircraft such as main wing, tail unit, and floor beam; secondary structural members such as flap, aileron, cowl, fairing, and other interior materials; and structural members of artificial satellites such as rocket motor case. Their preferred applications for general industrial uses include structural members of vehicles such as automobiles, ships, and railroad vehicles; and civil engineering and construction materials such as drive shafts, plate springs, windmill blades, various turbines, pressure vessels, flywheels, rollers for paper manufacture, roofing materials, cables, reinforcing bars, and mending/reinforcing materials. Applications in the sporting goods industry include golf shafts, fishing poles, rackets for tennis, badminton, squash, etc., hockey sticks, and skiing poles.

1-10. (canceled)

11. An epoxy resin composition comprising the constitutional elements [A], [B], [C], and [D] listed below, [A] accounting for 50 to 100 parts by mass in the total quantity 100 parts by mass of the epoxy resin, [B] accounting for 8 to 40 mass % in 100 mass % of the epoxy resin composition that excludes thermoplastic resin particle [D], and [B] having a glass transition temperature of 150° C. or more, the number of moles of the active hydrogen contained in [C] being 1.05 to 2.0 times as large as the number of moles of epoxy groups contained in the entire epoxy resin composition, [A], [B], and [C] having a single phase structure or a below-500-nm phase separated structure in cured material with a cure degree of 90% or more, as calculated by the Equation (2) given below from the total calorific value QT of the epoxy resin composition and the residual calorific value QR of the cured material, as determined by DSC (differential scanning calorimetry) produced by curing the epoxy resin composition, and the glass transition temperature X (° C.) and the rubber state elastic modulus Y (MPa), which is the storage elastic modulus at a temperature 50° C. higher than the glass transition temperature, of the cured material as determined by DMA (dynamic mechanical analysis) meeting the Equation (1) given below:
[A]amine type epoxy resin;
[B]thermoplastic resin that is dissolved in the epoxy resin;
[C]aromatic amine; and
[D]thermoplastic resin particle that is at least one resin selected from the group consisting of polyamide, polyimide, polyamideimide, polycarbonate, and polyphenylene sulfide, and that is insoluble in the epoxy resin;
0.19X/° C.-31.5≦Y/MPa≦0.19X/° C.-27 (1)
Cure degree (%)=(QT-QR)/QT×100 (2).

12. An epoxy resin composition as set forth in claim 11, wherein the thermoplastic resin [B] has a weight average molecular weight in the range of 4,000 to 40,000g/mol.

13. An epoxy resin composition as set forth in either claim 11, wherein the amine type epoxy resin [A] is at least one selected from the group consisting of tetraglycidyl diaminodiphenyl methane, triglycidyl aminophenol, halogen substitutes thereof, alkyl substitutes thereof, and hydrogenated products thereof.

14. An epoxy resin composition as set forth in claim 11, wherein the amine type epoxy resin [A] contains a bifunctional amine type epoxy resin and a tri- or more functional amine type epoxy resin.

15. An epoxy resin composition as set forth in claim 11, wherein the thermoplastic resin [B] is polyethersulfone.

16. An epoxy resin composition as set forth in claim 11, wherein the aromatic amine [C] is diaminodiphenyl sulfone or a derivative or isomer thereof.

17. Cured resin material produced by curing an epoxy resin composition as set forth in claim 11.

18. Prepreg produced by impregnating reinforcement fiber with an epoxy resin composition as set forth in claim 11.

19. Fiber reinforced composite material comprising reinforcement fiber and cured resin material as set forth in claim 17.

20. Fiber reinforced composite material produced by curing prepreg as set forth in claim 18.
